(19) United States
(12) Patent Application Publication
(10) Pub. No.: US 2003/0133577 A1
(43) Pub. Date: Jul. 17, 2003

(54) Microphone unit and sound source direction identification system

(76) Inventor: Makoto Yoshida, Iwata (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/314,425

(22) Filed: Dec. 6, 2002

(30) Foreign Application Priority Data
Dec. 7, 2001 (JP) 2001-374891

(51) Int. Cl. H04R 29/00; H04R 3/00

(52) U.S. Cl. 381/56; 381/92

(57) ABSTRACT

A microphone unit is provided to minimize the attenuation levels of received sound information, which differs depending upon the distance between the positions of microphones and a sound source. A sound source direction identification system is provided to identify the sound source direction. In addition, a moving head control system is provided, where the moving head control system includes a microphone system for receiving sound from a sound source, a sound source direction identification section for identifying the direction of the sound source by obtaining received sound information, a motor control section for generating an appropriate control command to a head moving motor, and a head moving motor for receiving the control command from the motor control section and moving or rotating a robot head in a direction according to the command.

### REFERENCE TO RELATED APPLICATIONS

The present application claims priority benefit of Japanese application number 2001-374891 filed Dec. 7, 2001.

### BACKGROUND OF THE INVENTION

1. Field of the Invention

The present invention relates to a microphone unit for identifying a sound source position or direction and a sound source direction identification system for identifying a sound source direction by receiving a sound with such microphone unit.

2. Description of the Related Art

Conventionally, there have been systems for calculating the phase difference between signals derived from sound information acquired with a plurality of microphones disposed at different positions, and identifying a sound source position or direction according to the calculated result.

However, in the conventional system described above, since the sound information as it propagates through space is attenuated in proportion to the inverse of the square of the distance between each microphone and the sound source, the attenuation level of the arrival sound information at each microphone will differ depending upon its position. Therefore, when the received sound waveforms are significantly different because of the positions of the microphones, the calculation of the phase difference becomes inaccurate, such that it can be difficult to identify the sound source position or direction.

### SUMMARY OF THE INVENTION

The present invention solves these and other problems by providing a microphone unit capable of reducing the difference between the attenuation levels of received sound information.

In one embodiment, the microphone unit includes a plurality of microphones spaced apart from each other and disposed within a space formed between opposing reverberative surfaces. In one embodiment, the space formed between the reverberative surfaces can be characterized as a cavity, or a slit. The space, cavity, or slit can be opened, such that it restricts the sound energy dispersion in one dimension. Alternatively, the space, cavity, or slit can be closed, such that it restricts the sound energy dispersion in more than one dimension.

A sound from a sound source arrives at the reverberative surfaces before arriving at the microphones. The sound is reflected by the reverberative surfaces, and subsequently arrives at the microphones. Since the microphones are disposed within the space formed between opposing reverberative surfaces, sound arriving at the reverberative surfaces reaches the microphones while reflecting between the reverberative surfaces. Therefore, it becomes possible to restrict the direction of the sound energy dispersion before it reaches the microphones. This reduces the difference in sound attenuation levels.

In one embodiment, the space in which the microphones are positioned can be formed by a substantially parallel arrangement of the reverberative surfaces to reduce the difference of sound attenuation levels.

In one embodiment, at least one of the reverberative surfaces is substantially circular in shape and the microphones are respectively disposed at positions in the vicinity of end points of a diameter of the circle. In such configuration, the microphones will be disposed approximately at the same distance from the center of the reverberative surfaces and the distance from the sound source to the reverberative surfaces can be approximately constant. Therefore, the sound attenuation level before arriving at the reverberative surfaces can be considered to be generally constant, and the attenuation level of the propagated sound within the space can be decreased by the reverberative surfaces. This allows the sound waveform from the same sound source to be distinguished. Moreover, by positioning the microphones in the vicinity of the ends of the substantially circular surface's diameter, the difference in the phase of the sound information received by each of the microphones is caused to be greater than if the microphones were closely positioned to each other. Increasing the difference in received phase information is useful in calculating angle of arrival, and the like.

In one embodiment, the space in the microphone unit is opened substantially along the entire circumference of the reverberative surfaces. In such embodiment, the space formed between the opposing reverberative surfaces is formed to be open substantially throughout its circumference so that all or substantially all of the sound information originating along the 360 degree circumference can be received by the microphones.

In one embodiment, a sound source direction identification system includes a microphone unit as described above and a sound source direction identifier, which identifies a sound source direction from the information received by the plurality of microphones of the microphone unit.

In such embodiment, the sound information from the sound source is received with the microphone unit as described above. The sound source direction is determined by the sound source direction identifier and the received sound information.

This system can be used, for example, with a pet-type robot or the like, or to enable a pet-type robot to act in response to the voice of a speaker.

### BRIEF DESCRIPTION OF THE DRAWINGS

FIG. 1 is a block diagram showing the configuration of a moving head control system.

FIG. 2 shows a robot on which the microphone unit is mounted.

FIG. 3 shows a phase difference of the arrival sounds at first and second microphones.

FIG. 4(a) is a plan view of a microphone unit as seen from the side.

FIG. 4(b) is a plan view of a microphone unit as seen along section line A-A.

FIG. 5 shows the distances between microphones and arrival points of a sound, where arrival points are the points on the reverberative surfaces where the sounds from a sound source arrive.

FIG. 6 shows sound dispersion when the sound source is within the microphone unit.

FIG. 7 shows sound dispersion when the sound source is not within the microphone unit, and when the sound is propagated within the microphone unit and reaches the microphones.

FIG. 8 is a flowchart showing the operational flow of a moving head control system for a robot.

### DETAILED DESCRIPTION

Embodiments in accordance with the present invention will be described hereinafter with reference to the drawings.

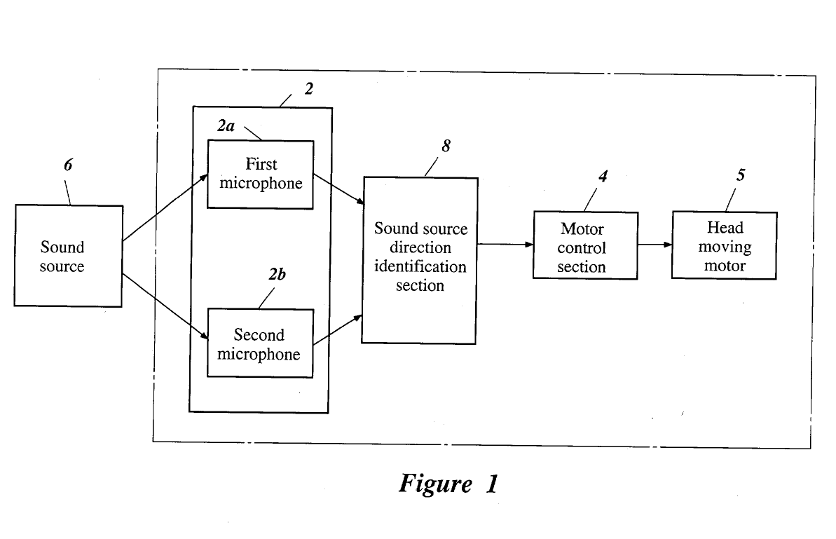

FIG. 1 is a block diagram showing the structure of a moving head control system in accordance with an embodiment of the present invention.

The moving head control system 1 includes a microphone system 2 for receiving sound from a sound source 6, a sound source direction identification section 3 for identifying the direction of the sound source 6 by obtaining received sound information, a motor control section 4 for generating an appropriate control command to control a head moving motor 5, and a head moving motor 5 for receiving the control command from the motor control section 4 and moving or rotating a robot head in response to the control command.

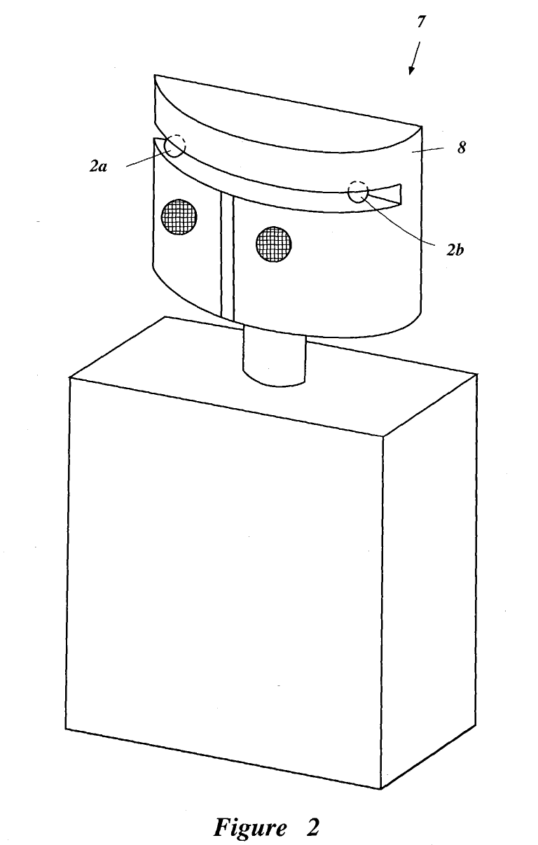

FIG. 2 shows a robot 7 on which the microphone unit 2 is mounted. As shown in FIG. 2, the microphone unit 2 is mounted on the head 8 of the robot 7. In this case, the cavity formed between the first and second reverberative surfaces 2c and 2d is adapted to be capable of propagating sound. The cavity can be opened, such that sound dispersion is restricted in one dimension. Alternatively, as shown in FIG. 2, the cavity can be closed, such that sound dispersion is restricted in more than one dimension.

The moving head control system 1 allows the robot 7 to respond to a sound radiated in its vicinity, such as a human voice or noise, by directing or rotating the head 8 in the direction of the sound source 6.

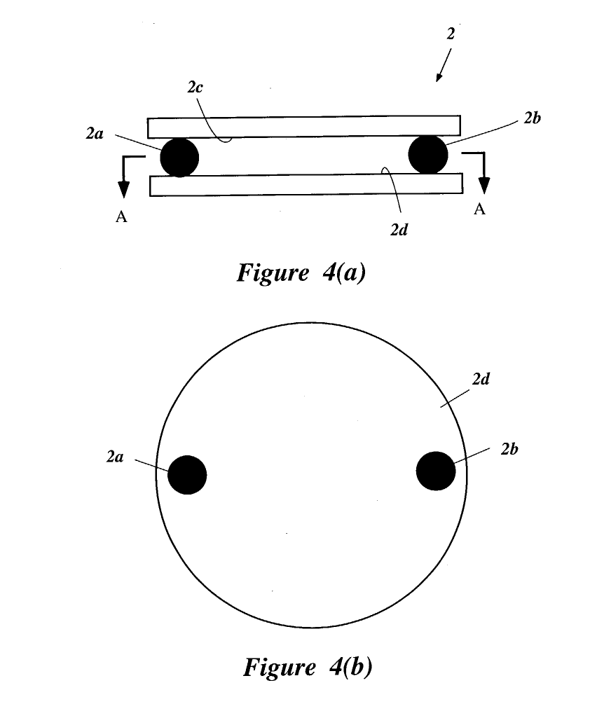

One aspect of the microphone unit 2 is that the first microphone 2a and the second microphone 2b can be disposed at positions within the cavity formed by opposing first reverberative surface 2c and second reverberative surface 2d, as shown in FIGS. 4(a) and 4(b). In such configuration, the sound from the sound source 6 is propagated in free space until it arrives at the microphone unit 2, and then propagates while repeatedly reverberating in the slit between the first reverberative surface 2c and the second reverberative surface 2d until it arrives at the first and second microphones 2a and 2b. The first reverberative surface 2c and second reverberative surface 2d restrict the sound propagation such that intensity decreases slower than a rate of 1/R².

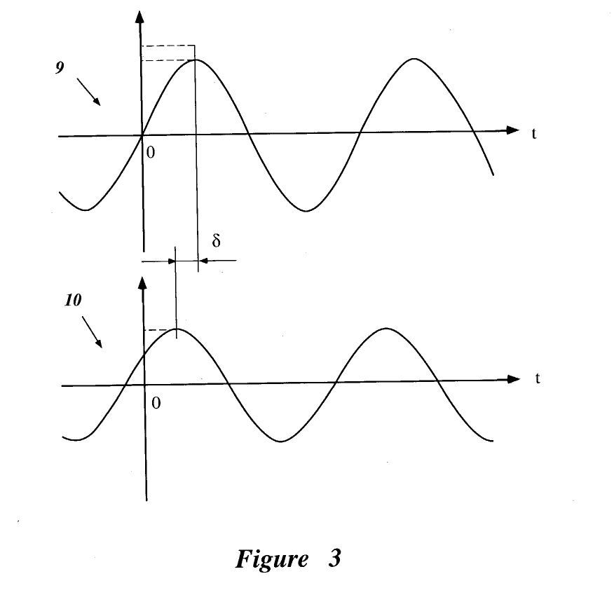

In addition, the sound source direction identification section 3 obtains the received sound information from the first microphone 2a and the second microphone 2b and then calculates a phase difference. FIG. 3 shows the phase difference between the arrival sounds at the first and second microphones 2a and 2b. A waveform 9 shows a first received sound waveform from the first microphone 2a, and a waveform 10 shows a second received sound waveform from the second microphone 2b. That is, the sound reception time point at the first or second microphone 2a or 2b can be set to zero, and then the received sound wave form data can be recorded during a desired time interval. The phase difference between the first received sound waveform 9 and the second received sound waveform 10 can be calculated from the data. The phase difference, or the difference in the arrival times of the waveforms, is shown as δ in FIG. 3.

Once the phase difference δ has been calculated, direction data of the sound source 6 can be determined. The sound source direction corresponding to the calculated phase difference δ can be calculated or retrieved from a database or lookup table.

The direction data of the sound source 6 is then transferred to the motor control section 4, where a control command corresponding to the direction data is generated and transferred to the head moving motor 5.

The head moving motor 5 receives the control command to drive the motor according to the command, and then moves or rotates the robot head 8 toward the sound source 6 direction.

Construction of one embodiment of the microphone unit is described with reference to FIGS. 4(a)-(b). FIG. 4(a) is a plan view seen from the side of the microphone unit 2. FIG. 4(b) is a plan view of the microphone unit 2 as seen along section line A-A.

As shown in FIG. 4(a), the microphone unit 2 has a first microphone 2a and a second microphone 2b disposed within a space between the reverberative surfaces. The space is formed between opposing first substantially circular shaped reverberative surface 2c and second substantially circular shaped reverberative surface 2d. In one embodiment, the first reverberative surface 2c and the second reverberative surface 2d are arranged so that they are substantially parallel to one another.

As shown in FIG. 4(b), the first microphone 2a and the second microphone 2b are respectively disposed in the vicinity of the end points of the diameters of the reverberative surfaces 2c and 2d. In such configuration, microphones 2a and 2b are disposed at approximately the same distance from the centers of each surface 2c and 2d. Furthermore, in this embodiment, the first and second reverberative surfaces 2c and 2d are made of material having sound reverberative characteristics (e.g., acrylic resin, metal, plastic, etc.). In one embodiment, the reverberative surface 2c is provided by a first reverberative plate and a second reverberative surface 2d is provided by a second reverberative plate.

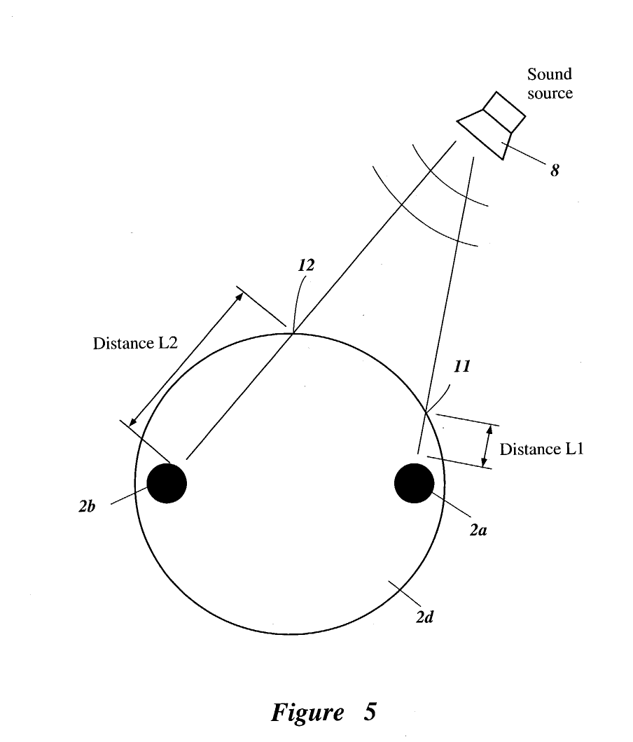

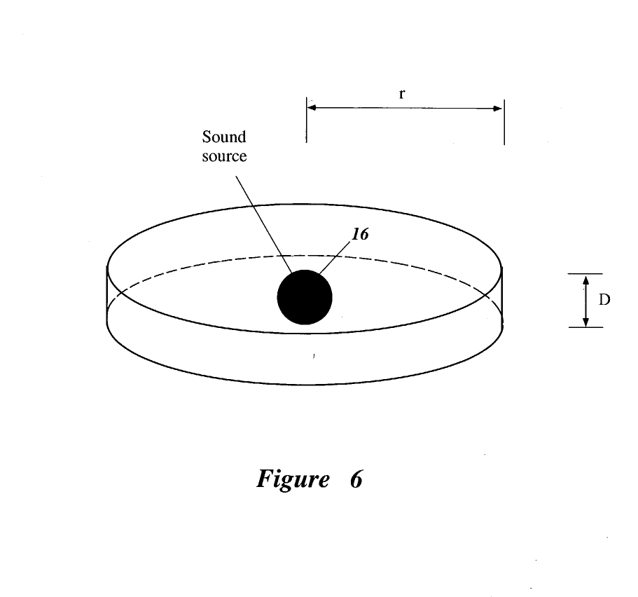

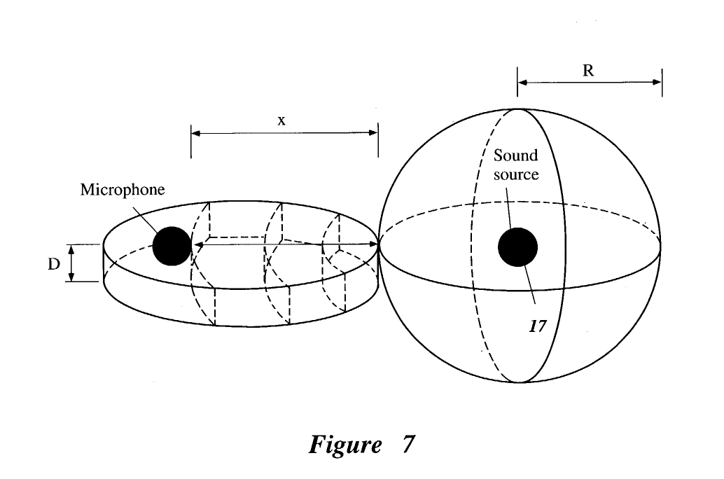

Sound dispersion according to the relative positions of the microphone unit 2 and a sound source 6 are described with reference to FIGS. 5, 6, and 7. FIG. 5 shows a sound radiating from a sound source 6, arriving at the reverberative surfaces 2c and 2d, and then arriving at microphones 2a and 2b. FIG. 6 shows the sound dispersion when the sound source 6 is within the microphone unit 2. FIG. 7 shows the sound dispersion from a sound source through a free space disposed outside of the microphone unit 2, propagating within the microphone unit 2, and arriving at microphones 2a and 2b.

As shown in FIG. 5, the sound from the sound source 6 is propagated in free space until it arrives at a first arrival point 11 at the microphone unit 2, and then arrives at microphone 2a after travelling an additional distance L1. The sound from sound source 6 also arrives at a second arrival point 12, and then arrives at microphone 2b after travelling an additional distance L2.

The sound propagated within the space between the first reverberative surface 2c and the second reverberative surface 2d will be described herein. As shown in FIG. 6, the width of the space between the first reverberative surface 2c and the second reverberative surface 2d is denoted by D. For purposes of explanation, a sound source 16 is disposed at the center of the substantially circular reverberative surfaces. Each of the surfaces has a radius r. The area of the side plane of the cylindrical column having height D and bounded by both reverberative surfaces can be expressed as 2πrD. If the sound source 16 is an omnidirectional sound source, then the acoustic power of the sound source 16 can be expressed as W₁ and the sound intensity I₁ at a distance r from the sound source 16 can be expressed as:

I₁=W₁/2πrD (1)

The sound intensity at a distance r from the sound source 16 is obtained by dividing the acoustic power W₁ by the side area of the cylinder of radius r (2πrD).

The sound dispersion from an omnidirectional sound source 17 through free space will be described with reference to FIG. 7. Sound dispersion occurs from the omnidirectional sound source 17 with acoustic power W₂. Sound intensity at a distance R from sound source 17 is I₂ and can be expressed as:

I₂=W₂/4πR² (2)

The sound intensity I₂ at a distance R from the sound source 17 is obtained by dividing the acoustic power W₂ by the surface area of the sphere formed about the sound source 17 with radius R. The intensity decreases at a rate of 1/R². The surface area of such sphere can be expressed as 4πR².

Therefore, as shown in FIG. 7, when the microphone unit 2 is disposed a distance R from the sound source 17 in free space and a microphone is disposed a distance x from the sound arrival point on a reverberative surface, and when the distance between the reverberative surfaces is denoted by D, and the sound intensity at the microphone is denoted by I₃, I₃ can be expressed as:

I₃=W₂/2πxD (3)

In other words, the sound intensity I₂ at a distance R from the sound source 17 in free space as obtained from equation (2) is substituted as the acoustic power W₁ into equation (1), and then the sound intensity at a distance x from there is obtained from equation (1).

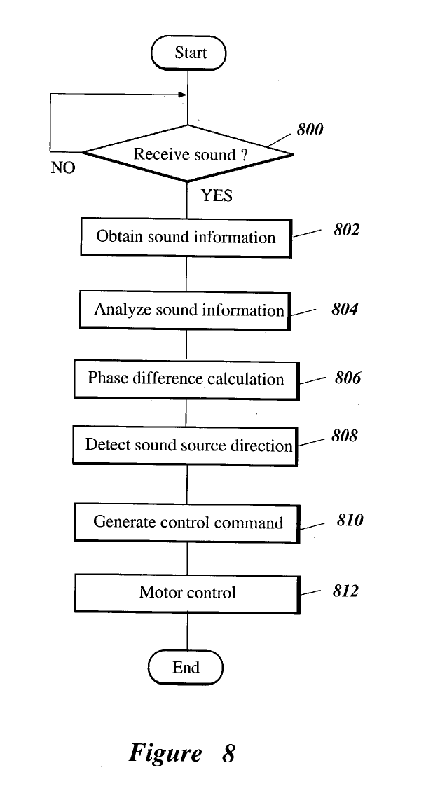

FIG. 8 is a flowchart showing the operational process of the moving head control system 1 of the robot 7. As shown in FIG. 8, the control system process enters process block 800 where it is determined whether the microphone unit 2 has received a sound or not. If a sound is received (Yes) the process proceeds to process block 802; otherwise, (No) the process loops back to process block 800.

When the process proceeds to process block 802, the sound information received by the first and second microphones 2a and 2b is sent to the sound source direction identification section 3, and the process continues to process block 804.

In process block 804 the sound information obtained by the sound source direction identification section 3 is analyzed, a sound wave form is extracted, and the process proceeds to process block 806.

In process block 806, the phase difference of the sounds that are extracted from the sound information received by the first microphone 2a and the second microphone 2b is calculated, and the process proceeds to process block 808.

In process block 808 sound source direction data corresponding to the calculated phase difference is calculated or is retrieved from the sound source direction database (not shown). The database stores sound source direction data that corresponds to phase differences. The sound source direction data is transferred to the control section 4, and the process proceeds to process block 810.

In process block 810 the appropriate control command is generated by the motor control section 4 based on the sound source direction data. The control command is then transferred to the head moving motor 5. The process then proceeds to process block 812.

In process block 812 the head moving motor 5 is activated based on the received control command, and the head 8 of the robot 7 is directed toward the sound source direction by the motor 5.

The microphone unit 2 and the moving head control system 1 using this unit have been described above. Additionally, since the microphone unit 2 has first and second microphones 2a and 2b, which are disposed within the space formed between the opposing first and second reverberative surfaces 2c and 2d, the sound propagated in free space is reverberated between the reverberative surfaces 2c and 2d when being propagated between them in the microphone unit 2. Therefore, the sound dispersion is restricted in one or more dimensional directions. By restricting sound dispersion, the attenuation level of the sound can be decreased compared to sound propagated through free space.

In one embodiment the shape of the first and second reverberative surfaces 2c and 2d are substantially circular to decrease the time it takes for the sound to arrive at the reverberative surfaces. Decreasing the sound arrival time provides an increase in the accuracy of the calculated phase difference.

In addition, the sound direction is identified in a manner such that the sound source direction data can be correspondingly determined from the database which stores the sound source direction data for the phase differences. Therefore, the phase difference of the sounds received by the first and second microphones 2a and 2b is calculated so that the sound source direction can be identified. This offers a benefit where a robot or the like is made to act in response to a sound.

One of ordinary skill in the art will recognize that more than two microphones can be provided. Furthermore, the space formed between the first and second reverberative surfaces 2c and 2d can be opened throughout the circumference such that the sound can be received from all directions, or closed in one or more respects.

Additionally, in some embodiments described above, although the shape of the first and second reverberative surfaces 2c and 2d are substantially circular, the shape of the first and second reverberative surfaces 2c and 2d can be rectangular, polygonal, elliptical, semi-circular irregular, etc. Various shape can be used without departing from the spirit and scope of this invention.

In the embodiments described above, although the sound source direction identification is performed by using sound phase difference, any identifying technique, such as using a correlation function, can alternatively be employed.

Additionally, in the embodiments described above, although the first and second reverberative surfaces 2c and 2d are made of acrylic resin, any material with sound reverberative properties can be used.

Furthermore, in the embodiments described above, the phase difference is calculated, and then the sound source direction data corresponding to the calculated result is retrieved from a database that stores sound source direction data that corresponds to phase differences. This sound source direction data is used to control the head 8 of the robot 7. Alternatively, the phase difference can be compared to a threshold value. If the phase difference exceeds the threshold value, the head 8 of the robot 7 can be moved or rotated towards the sound source 6 direction until the phase difference no longer exceeds the threshold value.

In addition, although the described embodiments are applied to control the head 8 of a robot 7 such that the head 8 moves or rotates in the direction of a sound source 6 in response to the sound, they can be applied to control an observing camera, the movement of other or all parts of a pet-type robot, or the like.

Accordingly, the scope of the invention is defined by the claims that follow.

What is claimed is:

1. A robot hearing system comprising:
a microphone unit, said microphone unit comprising:
a first microphone;
a second microphone;
a first reverberative plate; and
a second reverberative plate, wherein said first reverberative plate and said second reverberative plate oppose each other and form a cavity therebetween, and wherein said first microphone and said second microphone are spaced apart from each other and are disposed within said cavity; and
a sound source direction identifier for identifying a sound source direction according to sound from said sound source received by said first and second microphones.

2. The robot hearing system according to claim 1, wherein said sound source direction identifier comprises a database.

3. The robot hearing system of claim 1, wherein said first reverberative plate comprises acrylic resin.

4. The robot hearing system of claim 1 further comprising:
a robot head;
a motor controller; and
a motor, wherein said motor controller controls said motor to rotate said robot head in a direction depending upon a command received from said sound source direction identifier.

5. The robot hearing system according to claim 4, wherein said motor controller rotates said robot head towards said sound.

6. The robot hearing system according to claim 4, wherein said motor controller rotates said robot head to face said sound.

7. A microphone unit comprising:
a first microphone;
a second microphone;
a first reverberative surface; and
a second reverberative surface, wherein said first reverberative surface and said second reverberative surface oppose each other and form a space therebetween, and wherein said first microphone and said second microphone are spaced apart from each other and are disposed within said space.

8. The microphone unit according to claim 7, wherein said space is formed by a substantially parallel arrangement of said first reverberative surface and said second reverberative surface.

9. The microphone unit according to claim 7, wherein said first reverberative surface is substantially circular in shape and comprises a diameter comprising a first endpoint, a second endpoint, and a center, wherein said first microphone is disposed in a vicinity of said first endpoint of said diameter, wherein said second microphone is disposed in a vicinity of said second endpoint of said diameter, and wherein said first microphone and said second microphone are disposed approximately the same distance from the center of said diameter.

10. The microphone unit according to claim 7, wherein said first and second reverberative surfaces are substantially circular in shape and said first and second microphones are disposed proximate to endpoints of a diameter of said reverberative surfaces.

11. The microphone unit according to claim 7, wherein said space is opened substantially throughout its circumference.

12. The microphone unit according to claim 9, wherein said space is opened substantially throughout its circumference.

13. The microphone unit according to claim 7, wherein said first reverberative surface comprises acrylic resin.

14. A sound source direction identification system comprising:
a microphone unit, said microphone unit comprising:
a first microphone;
a second microphone;
a first reverberative plate; and
a second reverberative plate, wherein said first reverberative plate and said second reverberative plate oppose each other and form a space therebetween, and wherein said first microphone and said second microphone are spaced apart from each other and are disposed within said space; and
a sound source direction identifier for identifying a sound source direction according to sound received by said first and second microphones.

15. A method of sound location comprising:
coupling sound into a space between reverberating surfaces;
obtaining sound information from said sound between reverberating surfaces;
obtaining a phase difference from said sound information;
determining a sound source direction;
generating a control command; and
sending said control command to a motor controller.

16. A method of sound location comprising:
coupling sound into a space between reverberating surfaces;
detecting a first sound at a first location in said space;
detecting a second sound at a second location in said space;
analyzing said first and second sounds to determine a sound source direction.

17. The method of sound location according to claim 16, wherein said analyzing comprises determining a phase difference between said first and second sounds.

18. The method of sound location according to claim 16, wherein said analyzing comprises using a correlation function.

19. The method of sound location according to claim 16, wherein said analyzing comprises retrieving said sound source direction from a database.

20. The method of sound location according to claim 16 further comprising generating a control command.

21. The method of sound location according to claim 16 further comprising generating a control command and sending said control command to a motor.

22. The method of sound location according to claim 21, wherein said motor is provided to a robot head.

23. The method of sound location according to claim 21, wherein said motor is provided to a camera.

24. A method of sound location comprising:
coupling sound into a space between reverberating plates;
receiving a first sound;
receiving a second sound;
analyzing said first and second sounds to determine a direction of a source of said first and second sounds; and
generating a control command.

25. The method of robotic hearing according to claim 24, wherein said analyzing comprises determining whether a phase difference between said first and second sounds exceeds a first threshold value, and wherein said generating comprises generating a first rotate command if said phase difference exceeds said first threshold value.

26. The method of robotic hearing according to claim 25, wherein said analyzing further comprises determining whether said phase difference between said first and second sounds exceeds a second threshold value, and wherein said generating further comprises generating a second rotate command if said phase difference exceeds said second threshold value.

27. A robot hearing system comprising:
means for receiving a sound;
means for calculating a phase difference from said sound information;
means for determining a sound source direction;
means for generating a control command; and
means for sending said control command to a motor controller.

28. A robot hearing system comprising:
means for coupling sound into a space between reverberating plates;
means for detecting a first sound at a first location in said space;
means for detecting a second sound at a second location in said space;
means for analyzing said first and second sounds to determine a sound source direction.

29. The robot hearing system according to claim 28, wherein said means for analyzing comprises means for determining a phase difference between said first and second sounds.

30. The robot hearing system according to claim 28, wherein said means for analyzing comprises means for using a correlation function.

31. The robot hearing system according to claim 28, wherein said means for analyzing comprises means for retrieving said sound source direction from a database.

32. The robot hearing system according to claim 28 further comprising means for generating a control command.

33. The robot hearing system according to claim 28 further comprising means for generating a control command and means for sending said control command to a motor.

34. The robot hearing system according to claim 33, wherein said motor is provided to a robot head.

35. The robot hearing system according to claim 33, wherein said motor is provided to a camera.

36. A robot hearing system comprising:
means for coupling sound into a space between reverberating plates;
means for receiving a first sound;
means for receiving a second sound;
means for analyzing said first and second sounds to determine a direction of a source of said first and second sounds; and
means for generating a control command based on said direction.

37. The robot hearing system according to claim 36, wherein said means for analyzing comprises means for determining whether a phase difference between said first and second sounds exceeds a first threshold value, and wherein said means for generating comprises means for generating a first rotate command if said phase difference exceeds said first threshold value.

38. The robot hearing system according to claim 37, wherein said means for analyzing further comprises means for determining whether said phase difference between said first and second sounds exceeds a second threshold value, and wherein said means for generating further comprises means for generating a second rotate command if said phase difference exceeds said second threshold value.
